(19) United States
(12) Patent Application Publication
(10) Pub. No.: US 2022/0389890 A1
(43) Pub. Date: Dec. 8, 2022

(54) EGR VALVE DEVICE

(71) Applicant: AISAN KOGYO KABUSHIKI KAISHA, Obu-shi, Aichi (JP)

(72) Inventor: Koichi SUGIHARA, Chiryu-shi (JP)

(73) Assignee: AISAN KOGYO KABUSHIKI KAISHA, Obu-shi, Aichi (JP)

(21) Appl. No.: 17/774,326

(22) PCT Filed: Oct. 26, 2020
(86) PCT No.: PCT/JP2020/040038

§ 371 Date: May 4, 2022

(30) Foreign Application Priority Data
Nov. 20, 2019 (JP) 2019-209513

(51) Int. Cl. F02M 26/67; F16J 15/10

(52) U.S. Cl. CPC F02M 26/67; F16J 15/10

(57) ABSTRACT

An EGR valve device including a housing including a flow passage, a valve element that opens and closes the flow passage, a valve shaft to which the valve element is provided, and an outer housing including an assembly hole for the housing and other flow passages. When the housing is assembled in the assembly hole, an inlet and an outlet of the flow passage communicate with the other flow passages, and seal members are provided between the housing and the outer housing near the inlet and near the outlet. Assembly grooves are formed in the outer surface of the housing. A portion of each of the seal members that correspond to the assembly grooves has either an outer shape matching the shape of the assembly grooves or a shape formed by addition of a tightening margin to the outer shape.

### TECHNICAL FIELD

The present disclosure relates to an EGR valve system to be used to regulate a flow rate of EGR gas in an EGR passage.

### BACKGROUND ART

Conventionally, as a technique of the above type, for example, an EGR valve described in Patent document 1 listed below is known. This EGR valve is provided with a housing internally including an EGR gas passage (a flow passage), a valve seat provided in the flow passage, a valve element provided to be capable of seating on the valve seat, a valve shaft placed in the housing so as to extend through the flow passage and provided with the valve element, and a motor (a driving unit) for driving the valve shaft to reciprocate. The housing has a nearly cylindrical shape, provided with an inlet at one end in the axial direction and an outlet on the outer periphery of the housing. This EGR valve is mounted in an EGR passage, which is a mating member, by assembling (drop-in) of the housing in an assembly hole provided in the EGR passage. Herein, a sealing structure is provided between the outer periphery of the housing and the inner periphery of the assembly hole to seal a gap between them. This sealing structure includes two sealing members (conventional O-rings) arranged on the outer periphery of the housing, on both sides across the outlet of the flow passage. Herein, the conventional O-rings are referred to as a “sealing member having a circular cross-sectional shape taken in a. compression direction”.

### RELATED ART DOCUMENTS

### Patent Documents

Patent Document 1: Japanese unexamined patent application publication No. 2015-17506

### SUMMARY OF INVENTION

### Problems to be Solved by the Invention

Meanwhile, when the conventional O-ring is used as a sealing member in the EGR valve described in Patent Document 1. the following concerns arise, When the housing having the conventional O-ring attached thereto is dropped in an assembly hole of the mating member, the conventional O-ring may be twisted between the housing and the mating member. The thus conventional O-ring could not exhibit the sealing performance. In this case, further, both portions of the conventional O-ring, on the outer periphery side and the inner periphery side, are compressed, thus exhibiting the sealing performance. The compression rate of the conventional O-ring increases and thus the load on the housing due to a reaction force of the conventional O-ring tends to become large. Therefore, in order to reduce the reaction force load on the housing, it is necessary to design the housing thicker or to make it of highly rigid materials, leading to some problems in terms of weight reduction and cost reduction of the EGR valve.

The present disclosure has been made to address the above problems and has a purpose to provide an EGR valve device configured to prevent twisting of a sealing member when a housing is assembled into a mating member, and improve a sealing performance of the sealing member and reduce a reaction force load on the housing by the sealing member.

### Means of Solving the Problems

(1) To achieve the above-mentioned purpose, one aspect of the present disclosure provides an EGR valve device comprising: a housing including a flow passage for EGR gas, the flow passage including an inlet and an outlet provided in the housing; a valve element to open and close the flow passage; a valve shaft on which the valve element is provided; a mating member in which the housing is assembled, the mating member including: an assembly hole for the housing; and another flow passage, wherein when the housing is assembled in the assembly hole of the mating member, the inlet and the outlet of the flow passage communicate with the other flow passage, and a sealing member is provided between the housing and the mating member and located near the inlet and near the outlet, and wherein the housing has an outer surface formed with an assembly groove in which the sealing member is assembled, the assembly groove including a bottom surface and an opening, and the sealing member includes a portion corresponding to the assembly groove and having a shape that is either an outer shape matching the assembly groove or a shape formed by addition of a tightening margin to the outer shape.

According to the foregoing configuration (1), the portion of the sealing member corresponding to the assembly groove has the shape that is either the outer shape matching the assembly groove or the shape including the tightening margin in addition to the outer shape. The sealing member is therefore in tight contact with the assembly groove and is integral with the housing, so that there is no gap between the sealing member and the housing.

(2) To achieve the above-mentioned purpose, in the foregoing configuration (1), preferably, the bottom surface of the assembly groove is curved.

According to the above-described configuration (2), in addition to the operations of the configuration (1), the bottom surface of the assembly groove is curved, and the portion of the sealing member corresponding to the assembly groove has the outer shape matching the assembly groove. This configuration can achieve a larger contact area between the sealing member and the assembly groove.

(3) To achieve the above-mentioned purpose, in the foregoing configuration (1) or (2), preferably, the opening of the assembly groove has a width smaller than a width of the bottom surface.

According to the above-described configuration (3), in addition to the operations of the configuration (1) or (2), the opening of the assembly groove is formed with a narrower width than a width of the bottom surface, so that the sealing member is less likely to come off the assembly groove.

(4) To achieve the above-mentioned purpose, in one of the foregoing configurations (1) to (3), preferably, a part of the sealing member is in contact with an outer surface of the housing adjacent to the opening of the assembly groove.

According to the above-described configuration (4), in addition to the operations of one of the foregoing configurations (1) to (3), since a part of the sealing member is in contact with the outer surface of the housing adjacent to the opening of the assembly groove, the reaction force of the sealing member is partly received by the outer surface of the housing.

(5) To achieve the above-mentioned purpose, in one of the foregoing configurations (1) to (4), preferably, the sealing member is made of a rubber material filled in the assembly groove of the housing.

According to the above-described configuration (5), in addition to the operations of one of the foregoing configurations (1) to (4), the sealing member is made of a rubber material filled in the assembly groove of the housing, so that the sealing member and the assembly groove can be easily in tight contact with each other.

### Effects of the Invention

According to the foregoing configuration (1), it is possible to prevent twisting of the sealing member when the housing is assembled into the assembly hole of the mating member, thus improving the sealing performance of the sealing member and reducing the load on the housing due to the reaction force of the sealing member. Further, since the reaction force load exerted on the housing by the sealing member can be reduced, so that the material quality and the wall thickness of the housing can be reduced. This enables weight reduction and cost reduction of the housing.

According to the foregoing configuration (2), in addition to the effects of the above-described configuration (1), the sealing member can achieve a further improved sealing performance and the reaction force load on the housing by the sealing member can be further reduced.

According to the foregoing configuration (3), in addition to the effects of the above-described configuration (1) or (2), the sealing member can be assembled more firmly to the housing.

According to the foregoing configuration (4), in addition to the effects of one of the above-described configurations (1) to (3), the reaction force of the sealing member to the housing can be further distributed and thus the reaction force load on the housing can be further reduced.

According to the foregoing configuration (5), in addition to the effects of one of the above-described configurations (1) to (4), the sealing member and the housing can be more firmly integrated with each other.

### BRIEF DESCRIPTION OF THE DRAWINGS

FIG. 1 is a front view of an EGR valve device including a partial cross-sectional view in a first embodiment;

FIG. 2. is an exploded front view of the EGR valve device including a partial cross-sectional view in the first embodiment;

FIG. 3 is a perspective view of a valve assembly in the first embodiment;

FIG. 4 is an enlarged cross-sectional view showing a second assembly groove and a second sealing member enclosed by a dot-dashed circle in FIG. 2 in the first embodiment;

FIG. 5 is an enlarged cross-sectional view showing the second assembly groove and the second sealing member enclosed by a dot-dashed circle in FIG. 1 in the first embodiment;

FIG. 6 is an enlarged cross-sectional view showing a distribution of reaction force on an outer housing and a housing by the second sealing member in the first embodiment;

FIG. 7 is an enlarged cross-sectional view of a second assembly groove and a second sealing member in a second embodiment, corresponding to FIG. 4;

FIG. 8 is an enlarged cross-sectional view of the second assembly groove and the second sealinge ber in the second embodiment, corresponding to FIG. 5;

FIG. 9 is an enlarged cross-sectional view showing a distribution of reaction force on an outer housing and a housing by the second sealing member in the second embodiment;

FIG. 10 is an enlarged cross-sectional view of a second assembly groove and a second sealing member in a third embodiment, corresponding to FIG. 4;

FIG. 11 is an enlarged cross-sectional view of the second assembly groove and the second sealing member in the third embodiment, corresponding to FIG. 5;

FIG. 12 is an enlarged cross-sectional view showing a distribution of reaction force on an outer housing and a housing by the second sealing member in the third embodiment;

FIG. 13 is a perspective view of a valve assembly in a fourth embodiment;

FIG. 14 is a perspective view of a valve assembly in a fifth embodiment;

FIG. 15 is a perspective view of a valve assembly in a sixth embodiment;

FIG. 16 is an enlarged cross-sectional view of an assembly groove and a. sealing member in another embodiment, corresponding to FIG. 4; and

FIG. 17 is an enlarged cross-sectional view of an assembly groove and a sealing member in another embodiment, corresponding to FIG. 4.

### MODE FOR CARRYING OUT THE INVENTION

A detailed description of several embodiments of an EGR valve device will now be given referring to the accompanying drawings.

### First Embodiment

A first embodiment of the EGR valve device will be described first below.

### (Configuration of EGR Valve Device)

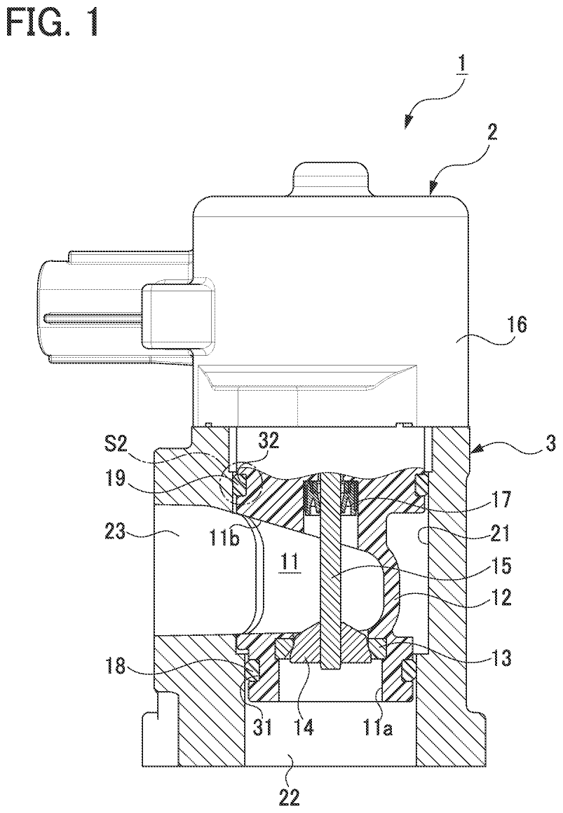

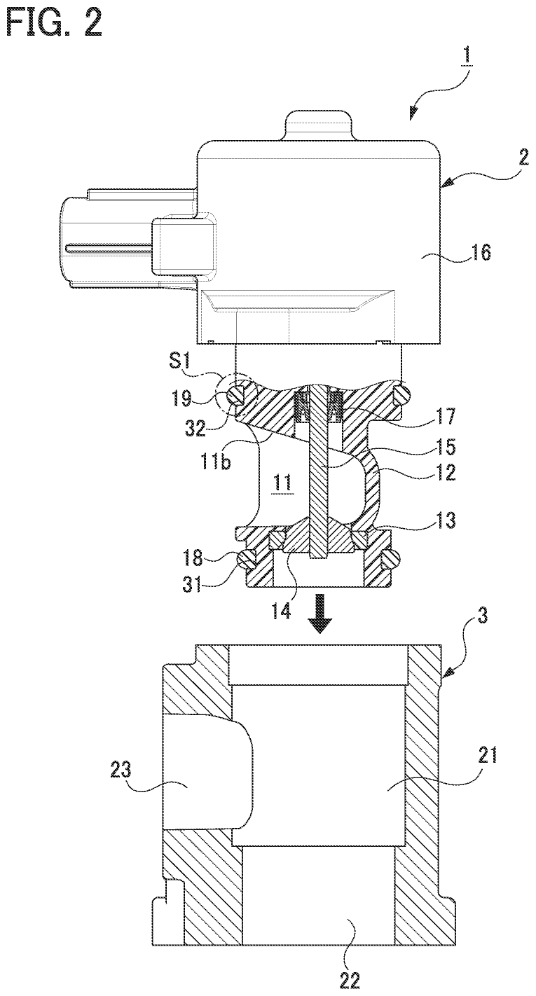

FIG. 1 is a front view of an EGR valve device 1 including a partial cross-sectional view in the present embodiment. FIG. 2 is an exploded front view of the EGR valve device 1 including a partial cross-sectional view. HG. 3 is a perspective view of a valve assembly 2 constituting the EGR valve device 1. The EGR valve device 1 is to be placed in an EGR passage (not shown) connected to an intake passage to allow a part of exhaust gas discharged from an engine to an exhaust passage to recirculate as EGR gas to the engine. The EGR valve device 1 is used to regulate a flow rate of the EGR gas in the EGR passage.

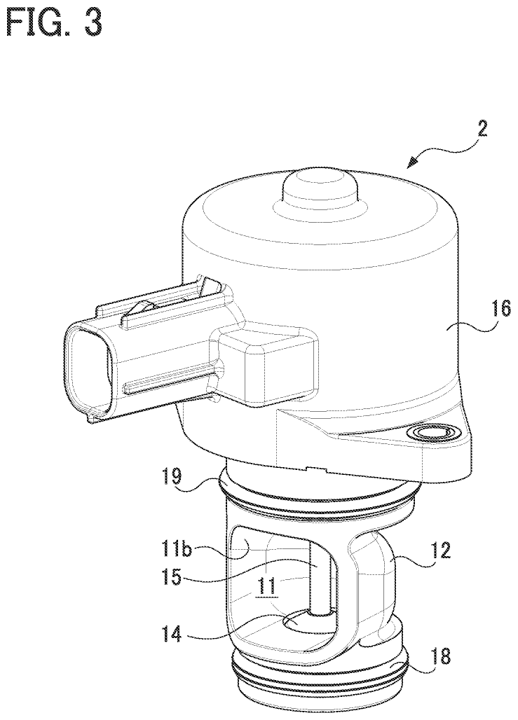

As shown in FIGS. 1 to 3, the EGR valve device 1 has a poppet valve structure and mainly consists of a valve assembly 2 and an outer housing 3 in which a housing 12 of the valve assembly 2 is assembled. The outer housing 3 is made of a metal material and corresponds to a mating member of the present disclosure. The valve assembly 2 is provided with the housing 12 having a nearly cylindrical shape and including a flow passage 6 for EGR gas, an annular valve seat 13 provided in the flow passage 11, a nearly-umbrella-shaped valve element 14 provided to be capable of seating on the valve seat 13 to open and close the flow passage 11, a valve shaft 15 having one end to which the valve element 14 is provided, and a driving unit 16 for driving the valve shaft 15 to reciprocate together with the valve element 14. The housing 12 of the present embodiment is made of a resin material. The driving unit 16 may be constituted of a DC motor, for example.

As shown in FIGS. 1 and 2, the flow passage 11 of the housing 12 extends bending in a nearly L-shape and includes an inlet 11a and an outlet 11b. In the present embodiment, the inlet 11a opens at the lower end of the housing 12 in the axial direction and the outlet 11b opens at the outer periphery of the housing 12. In the present embodiment, the valve seat 13 and the valve element 14 are made of a metal material. The shapes of the valve seat 13 and the valve element 14 are one examples. The valve seat 13 is provided in the housing 12 by insert molding. The valve assembly 1 is configured to move the valve element 14 with respect to the valve seat 13 to change an opening degree between the valve element 14 and the valve seat 13, thereby regulating a flow rate of EGR gas in the flow passage 11. In the present embodiment, the details of the driving unit 16 are omitted.

The valve shaft 15 extending downward from the driving unit 16 is inserted in the housing 12. The valve shaft 15 is placed in parallel to the axis of the valve seat 13. The valve element 14 is configured to seat on (contact with) and separate from the valve seat 13 in association with reciprocating movement of the valve shaft 15. Between the housing 12 and the valve shaft 15, a lip seal 17 is provided to seal between the housing 12 and the valve shaft 15. In the present embodiment, the valve element 14 is placed to make reciprocation at the lower (upstream) side of the valve seat 13.

As shown in FIGS. 1 and 2, in the present embodiment, the outer housing 3 has a nearly cylindrical shape and includes an assembly hole 21 for the housing 12, an inlet flow passage 22, and an outlet flow passage 23. This EGR valve device 1 is made up by assembling the housing 12 of the valve assembly 2 into the assembly hole 21 of the outer housing 3. Herein, when the housing 12 is assembled in the assembly hole 21, the inlet flow passage 22 communicates with the inlet 11a of the housing 12 and the cutlet flow passage 23 communicates with the outlet 11b of the housing 12. The inlet flow passage 22 and the outlet flow passage 23 each constitute another flow passage of the present disclosure.

As shown in FIGS. 1 to 3, in the present embodiment, between the housing 12 and the outer housing 3, two sealing members 18 and 19 are provided respectively near the inlet 11a and near the outlet 11b of the housing 12. Specifically, the first sealing member 18 and the second sealing member 19 are provided on the outer surface of the housing 12, on both sides across the outlet 11b. That is, the first sealing member 18 is placed on the outer periphery of the housing 12, below the outlet 11b, and near the inlet 11a and around the inlet 11a. The second sealing member 19 is placed on the outer periphery of the housing 12, above the outlet 11b.

(Sealing Member)

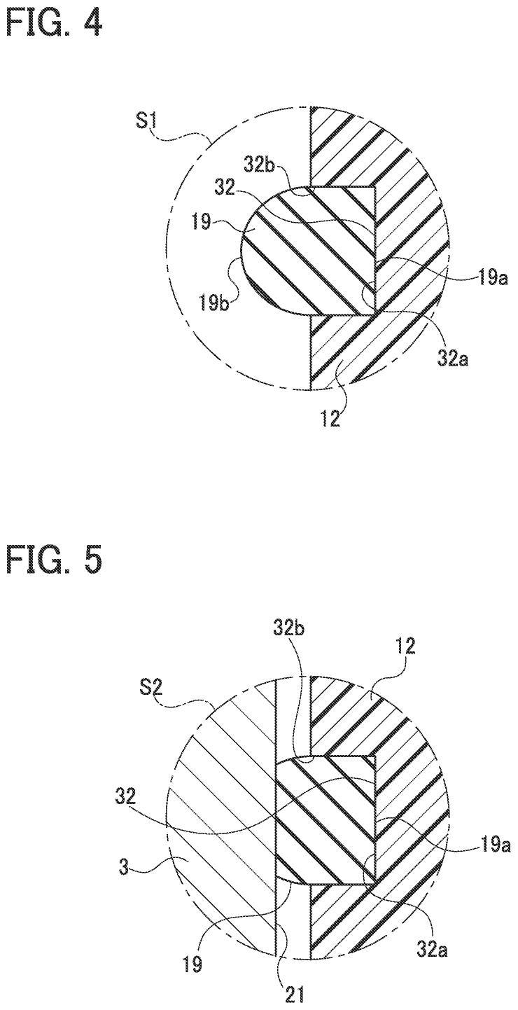

FIG. 4 is an enlarged cross-sectional view of a second assembly groove 32 and the second sealing member 19, enclosed by a dot-dashed circle S1 in FIG. 2, in the valve assembly 2 of the present embodiment. FIG. 5 is an enlarged cross-sectional view of the second assembly groove 32 and the second sealing member 19, enclosed by a dot-dashed circle S2 in FIG. 1, in the EGR valve device 1 of the present embodiment. In the present embodiment, each of the two sealing members 18 and 19 is formed of an improved rubber O-ring. As shown in FIGS. 1 to 5, the housing 12 includes, in the outer periphery, a first assembly groove 31 at a location where the first sealing member 18 is mounted and a second assembly groove 32 at a location where the second sealing member 19 is mounted. Herein, the first sealing member 18 and the second sealing member 19 have the same shape. Further, the first assembly groove 31 and the second assembly groove 32 also have the same shape. As shown in FIGS. 4 and 5, each of the assembly grooves 31 and 32 has a bottom surface 32a and an opening 32b. In this embodiment, the bottom surface 32a and the opening 32b are designed with the same width. Herein, the portion of the sealing member 18 and the portion of the sealing member 19, respectively corresponding to the assembly grooves 31 and 32, each have a shape that matches the corresponding assembly grooves 31 and 32. In the present embodiment, the sealing members 18 and 19 are respectively provided in the assembly grooves 31 and 32 by baking. In other words, the sealing members 18 and 19 are made of a rubber material filled in the corresponding assembly grooves 31 and 32.

In the present embodiment, each of the sealing members 18 and 19 has a cross-sectional shape with a flat bottom surface 19a on the inner periphery side and a semi-circularly curved top surface 19b on the outer periphery side, as shown in FIGS. 4 and 5. When the housing 12 is assembled in the assembly hole 21 of the outer housing 3, the outer periphery side (the top surface 19b side) of each of the sealing members 18 and 19 is crushed in contact with the inner surface of the assembly hole 21 as shown in FIG. 5, but the inner periphery side (the bottom surface 19a side) of each sealing member 18 and 19 remains unchanged in shape.

(Operations and Effects of EGR Valve Device)

According to the configuration of the EGR valve device 1 of the present embodiment described above, when the housing 12 of the valve assembly 2 is assembled in the assembly hole 21 of the outer housing 3 (the mating member), the inlet 11a of the flow passage 11 of the housing 12 communicates with the inlet flow passage 22 of the outer housing 3 and the outlet 11b of the flow passage 11 communicates with the outlet flow passage 23 of the outer housing 3. Herein, the first sealing member 18 is placed between the housing 12 and the outer housing 3, corresponding to the periphery of the inlet 11a of the housing 12. This first sealing member 18 seals between the housing 12 and the outer housing 3 at the periphery of the inlet 11a. Further, the first sealing member 18 and the second second sealing member 19 are placed between the housing 12 and the outer housing 3, above and below across the outlet 11b of the housing 12 and near the outlet 11b. Those sealing members 18 and 19 seal between the the housing 12 and the outer housing 3 in the vicinity of the outlet 11b. Accordingly, when the housing 12 is assembled in the outer housing 3 (the mating member), it is possible to prevent EGR gas and condensate water from entering between the boundary surfaces of the housing 12 and the outer housing 3, near the inlet 11a and near the outlet 11b of the housing 12, and further prevent leakage of EGR gas from the flow passage 11 to the outside and suction of outside air from the outside of the flow passage 11 and further prevent collection of the condensate water on the boundary surfaces or corrosion of metal parts due to the condensate water.

According to the configuration of the present embodiment, the sealing members 18 and 19 include the portions that correspond to their respective assembly^{,} grooves 31 and 32 and have the outer shapes that match the assembly grooves 31 and 32. Thus, the sealing members 18 and 19 are respectively in close contact with the assembly grooves 31 and 32 and integrated with the housing 12, so that there is no gap between each of the sealing members 18 and 19 and the housing 12. This configuration can prevent twisting of the sealing members 18 and 19 when the housing 12 is assembled into the assembly hole 21 of the outer housing 3 (the mating member), improve the sealing performance of each sealing member 18 and 19, and further reduce the load on the housing 12 due to the reaction force of the sealing members 18 and 19. Since this configuration can reduce the reaction force load on the housing 12 by the sealing members 18 and 19, the housing 12 can be made of a material having a lower rigidity or a thinner wall thickness, thereby achieving weight reduction and cost reduction of the housing 12.

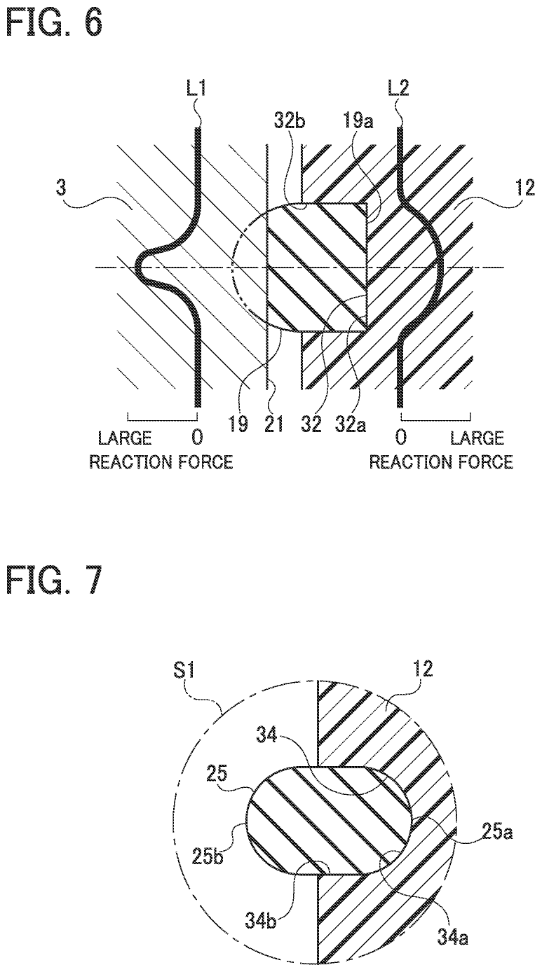

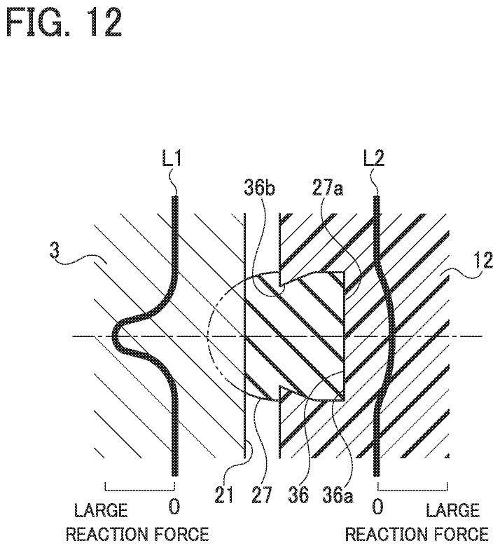

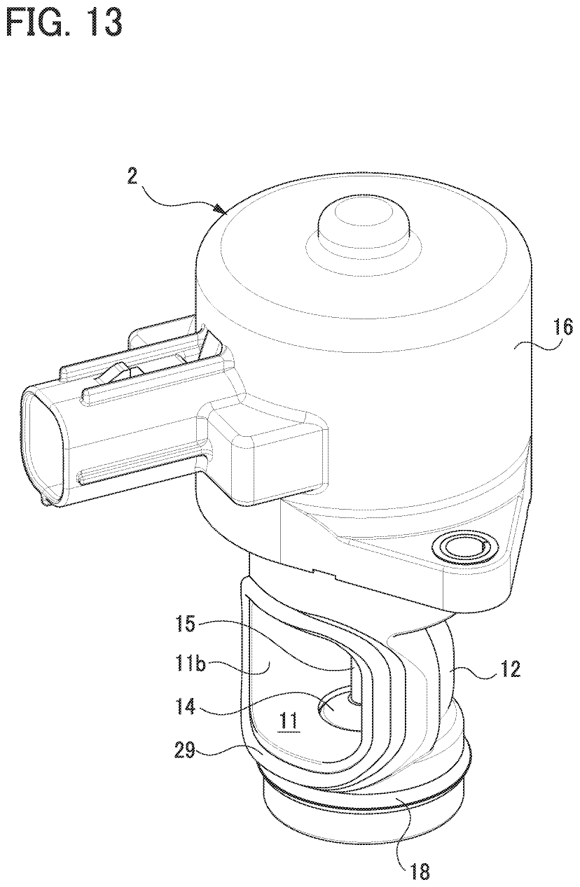

FIG. 6 is an enlarged cross-sectional view of the distribution of reaction force on the outer housing 3 and the housing 12 by the second sealing member 19 in the EGR valve device 1 of the present embodiment. In FIG. 6, a first distribution curve L1 indicates the reaction force distribution on the outer housing 3 side and a second distribution curve L2 indicates the reaction force distribution on the housing 12 side (the same applies to FIGS. 9 and 12 which will be mentioned later). As shown in FIG. 6, the distribution of the reaction force exerted by the second sealing member 19 has a peak value lower on the housing 12 side than on the outer housing 3 side. Further, the reaction force distribution by the second sealing member 19 has a distribution range wider on the housing 12 side than on the outer housing 3 side. Herein, it is known that the distribution of the reaction force by the conventional O-ring, which is a sealing member having a circular cross-sectional shape in the compression direction, is the same between on the housing side and on the outer housing 3 side shown in FIG. 6. In the present embodiment, therefore, it is revealed as shown in FIG. 6 that the reaction force distribution on the housing 12 side by the second sealing member 19 is suppressed lower over a wide range than on the outer housing 3 side.

According to the configuration of the present embodiment, the sealing members 18 and 19 are made of a rubber material filled in respective assembly grooves 31 and 32 of the housing 12, thus enabling easy close contact of the sealing members 18 and 19 with the corresponding assembly grooves 31 and 32. This can achieve firm integrationof each sealing member 18 and 19 with the housing 12.

### Second Embodiment

A second embodiment will be described below, In the following description, identical or similar parts to those in the first embodiment are assigned the same reference signs as those in the first embodiment. The following explanation is given with a focus on differences from the first embodiment. The second embodiment differs from the first embodiment in the structures of a sealing member and an assembly groove.

(Sealing Member)

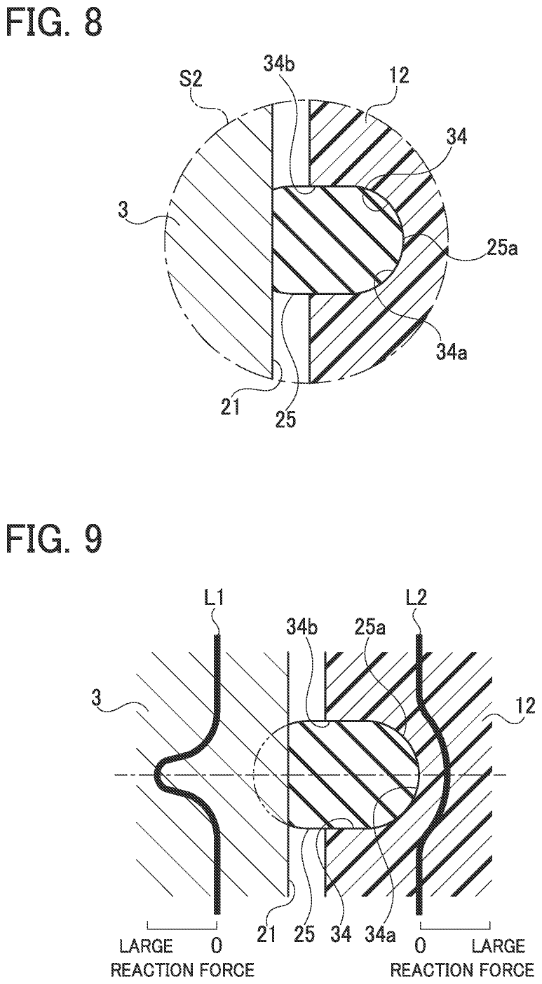

FIG. 7 is an enlarged cross-sectional view of a second assembly groove 34 and a second sealing member 25 in the valve assembly 2 of the present embodiment, corresponding to FIG. 4. FIG. 8 is an enlarged cross-sectional view of the second assembly groove 34 and the second sealing member 25 in the EGR valve device 1 of the present embodiment, corresponding to FIG. 5. In the present embodiment, the first assembly groove has the same configuration as the second assembly groove 34 and the first sealing member has the same configuration as the second sealing member 25. Thus, only the second assembly groove 34 and the second sealing member 25 will be described below (the same applies to the subsequent descriptions).

In the present embodiment, as shown in FIGS. 7 and 8, the second assembly groove 34 has a bottom surface 34a that is a curved surface having a semi-circular cross-section. The second assembly groove 34 is formed with the bottom surface 34a and an opening 34b which have the same width. Herein, a portion of the second sealing member 25 corresponding to the second assembly groove 34 has an outer shape matching the second assembly groove 34. Even in this embodiment, the second sealing member 25 is provided by baking to the second assembly groove 34. In the present embodiment, as shown in FIG. 7, the second sealing member 25 has a cross-sectional shape with a semi-circularly curved bottom surface 25a on the inner periphery side and also a semi-circularly curved top surface 25b on the outer periphery side. When the housing 12 is assembled in the assembly hole 21 of the outer housing 3, the outer periphery side (the top surface 25b side) of the second sealing member 25 is crushed in contact with the inner surface of the assembly hole 21 as shown in FIG. 8, but the inner periphery side (the bottom surface 25a side) of the second sealing member 25 remains unchanged in shape.

(Operations and Effects of EGR Valve Device)

According to the configuration of the EGR valve device 1 of the present embodiment described above, it can provide the equivalent operations and effects to those in the first embodiment. In the present embodiment, furthermore, the bottom surface 34a of the second assembly groove 34 is a curved surface, and the portion of the second sealing member 25 corresponding to the second assembly groove 34 has the same outer shape as the second assembly groove 34. This configuration can provide a larger contact area between the second sealing member 25 and the second assembly groove 34 as compared with the first embodiment. It is therefore possible to further improve the sealing performance of the second sealing member 25 and further reduce the reaction force load on the housing 12 by the second sealing member 25, as compared with the first embodiment. The same applies to the first sealing member and the first assembly groove.

FIG. 9 is an enlarged cross-sectional view showing the distribution of reaction force on the outer housing 3 and the housing 12 by the second sealing member 25 in the EGR valve device 1 of the present embodiment. As shown in FIG. 9, the distribution of the reaction force exerted by the second sealing member 25 has a peak value even lower on the housing 12 side than on the outer housing 3 side as compared with the first embodiment. The distribution of the reaction force exerted by the second sealing member 25 has a wider distribution range on the housing 12 side than on the outer housing 3 side. In the present embodiment, therefore, as shown in FIG. 9, it is revealed that the reaction force distribution on the housing 12 side by the second sealing member 25 is suppressed even lower over a wide range than in the first embodiment.

### Third Embodiment

A third embodiment will be described below. This third embodiment also differs from each of the foregoing embodiments in the structures of a sealing member and an assembly groove.

(Sealing Member)

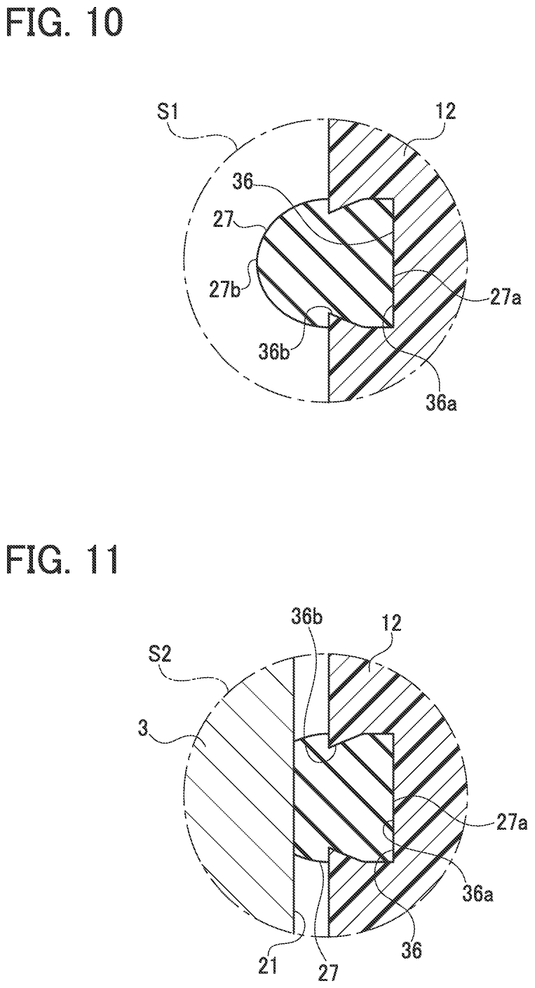

FIG. 10 is an enlarged cross-sectional view of a second assembly groove 36 and a second sealing member 27 in the valve assembly 2 of the present embodiment, corresponding to FIG. 4. FIG. 11 is an enlarged cross-sectional view of the second assembly groove 36 and the second sealing member 27 in the EGR valve device 1 of the present embodiment, corresponding to FIG. 5.

In the present embodiment, as shown in FIGS. 10 and 11, the second assembly groove 36 has a bottom surface 36a that is flat. The second assembly groove 36 has an opening 36b with a narrower width than a width of the bottom surface 36a. The second assembly groove 36 has a side surface sloping from a middle in the depth direction toward the opening 36b. Herein, a portion of the second sealing member 27 corresponding to the second assembly groove 36 has the outer shape matching the shape of the second assembly groove 36. In this embodiment, similarly, the second sealing member 27 is provided by baking to the second assembly groove 36. In the present embodiment, the second sealing member 27 has a cross-sectional shape with a bottom surface 27a on the inner periphery side is flat and a semi-circularly curved top surface 27b on the outer periphery side, as shown in FIG. 10. In the present embodiment, further, the second sealing member 27 is formed with a mushroom-like cross-sectional shape so that a part of the second sealing member 27 is in contact with the outer surface of the housing 12 adjacent to the opening 36b of the second assembly groove 36. When the housing 12 is assembled in the assembly hole 21 of the outer housing 3, the outer periphery side (the top surface 27b side) of the second sealing member 27 is crushed in contact with the inner surface of the assembly hole 21 as shown in FIG. 11, but the inner periphery side (the bottom surface 27a side) of the second sealing member 27 remains unchanged in shape.

(Operations and Effects of EGR Valve Device)

According to the configuration of the EGR valve device 1 of the present embodiment described above, it can provide the equivalent operations and effects to those in the first embodiment. In the present embodiment, additionally, the opening 36b of the second assembly groove 36 is formed with the narrower width than the bottom surface 36a, thus making the second sealing member 27 less likely to come off the second assembly groove 36. This configuration can more firmly mount the second sealing member 27 in the housing 12 as compared with the first embodiment. The same applies to the first sealing member and the first assembly groove.

According to the configuration of the present embodiment, a part of the second sealing member 27 is in contact with the outer surface of the housing 12 adjacent to the opening 36b of the second assembly groove 36, so that the reaction force of the second sealing member 27 is partly received by the outer surface of the housing 12. Therefore, this configuration can further distribute the reaction force on the housing 12 by the second sealing member 27 as compared with the first embodiment, and thus can further reduce the reaction force load on the housing 12. The same applies to the first sealing member and the first assembly groove.

FIG. 12 is an enlarged cross-sectional view of the distribution of reaction force on the outer housing 3 and the housing 12 by the second sealing member 27 in the EGR valve device 1 of the present embodiment. As shown in FIG. 12, the distribution of the reaction force exerted by the second sealing member 27 has a peak value even lower on the housing 12 side than on the outer housing 3 side as compared with the second embodiment. Also, the reaction force distribution by the second sealing member 27 has a distribution range wider on the housing 12 side than on the outer housing 3 side. In the present embodiment, therefore, it is revealed as shown in FIG. 12 that the reaction force distribution on the housing 12 side by the second sealing member 27 is further suppressed even lower over a wide range as compared with the second embodiment.

### Fourth Embodiment

A fourth embodiment will be described below. The present embodiment differs from each of the foregoing embodiments in the location of the second sealing member in the housing 12.

(Sealing Member)

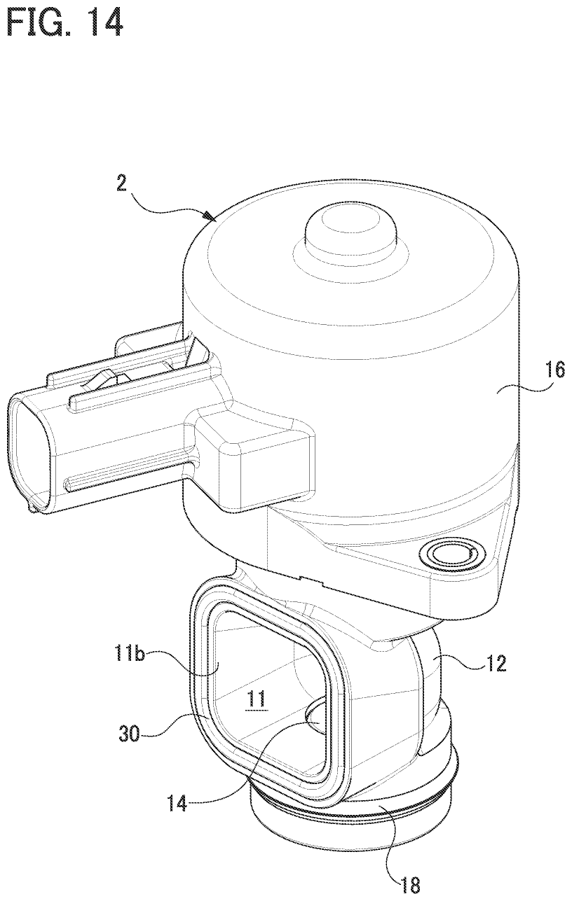

FIG. 13 is a perspective view of the valve assembly 2. In the present embodiment, the first sealing member 18 is placed in the housing 12 at the same location as that in each of the foregoing embodiments, and the second sealing member 29 is placed in the housing 12 at a location corresponding to the circumference of the outlet 11b. Specifically, a second assembly groove is formed around the opening of the outlet 11b so as to surround the outlet 11b along the curved outer surface of the housing 12. The second sealing member 29 is mounted in this second assembly groove. When the second sealing member 29 is mounted in the second assembly groove, the second sealing member 29 is curved to conform to the curvature around the opening of the outlet 11b. In the present embodiment, the first sealing member 18 and the second sealing member 29 are respectively provided by baking to the first assembly groove and second assembly groove. In the present embodiment, the cross-sectional shape of each of the first sealing member 18 and the second sealing member 29 and the cross-sectional shape of each of the first assembly groove and the second assembly groove may be designed to be the same as those in each of the foregoing embodiments.

(Operations and Effects of EGR Valve Device)

According to the configuration of the EGR valve device 1 of the present embodiment described above, it can provide the equivalent operations and effects to those in each of the foregoing embodiments.

### Fifth Embodiment

A fifth embodiment will be described below. This embodiment differs from each of the foregoing embodiments in the location and the shape of the second sealing member in the housing 12.

(Sealing Member)

FIG. 14 is a perspective view of the valve assembly 2. A second sealing member 30 of the present embodiment differs mainly in the shape from the second sealing member 29 in the fourth embodiment. In the present embodiment, specifically, as shown in FIG. 14, the outer surface of the housing 12 around the outlet 11b (around the opening) is flat in parallel to the valve shaft 15, not curved around the valve shaft 15. Further, the inner surface of the assembly hole of the outer housing, corresponding to the outer surface around the opening of the outlet 11b, is flat to match the flat outer surface around the opening of the outlet 11b.

In the present embodiment, as shown in FIG. 14, the second sealing member 30 is mounted in the flat outer surface of the housing 12 around the opening of the outlet 11b. Specifically, the flat outer surface around the opening of the outlet 11b is formed with a second assembly groove (not shown) so as to surround the outlet 11b. The second sealing member 30 is mounted in this second assembly groove. When the second sealing member 30 is mounted in the second assembly groove, the second sealing member 30 extends in a flat manner to conform to the flatness around the opening of the outlet 11b. In the present embodiment, the first sealing member 18 and the second sealing member 30 are also provided by baking respectively to the first assembly groove and second assembly groove. In the present embodiment, the cross-sectional shape of each of the first sealing member 18 and the second sealing member 30 and the cross-sectional shape of each of the first assembly. groove and the second assembly groove can be designed to be the same as those in each of the foregoing embodiments.

(Operations and Effects of EGR Valve Device)

The configuration of the EGR valve device 1 of the present embodiment described above can provide the equivalent operations and effects to those in each of the foregoing embodiments.

### Six Embodiment

A sixth embodiment will be described below. This embodiment differs in the location and the shape of the second sealing member in the housing 12 from each of the foregoing embodiments.

(Sealing Member)

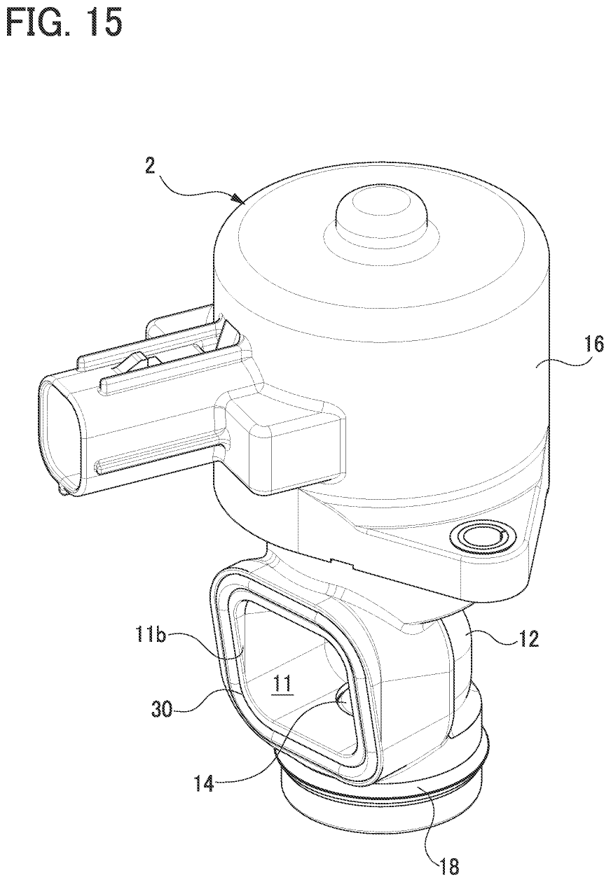

FIG. 15 is a perspective view of the valve assembly 2. A second sealing member 30 of the present embodiment differs mainly in the location from that in the fifth embodiment. In the present embodiment, specifically, as shown in FIG. 15, the outer surface of the housing 12 around the the outlet 11b (around the opening) is flat and inclined with respect to a direction coaxial with the valve shaft 15 in an orientation approaching the valve shaft 15 in a direction of assembly into the assembly hole 21. The inner surface of the assembly hole 21 of the outer housing 3, corresponding to the outer surface around the opening of the outlet 11b, is flat and inclined to match the inclined flat outer surface around the opening of the outlet 11b.

In the present embodiment, as shown in in FIG. 15, the second sealing member 30 is provided corresponding to the inclined flat outer surface around the opening of the outlet 11b of the housing 12. Specifically, the inclined flat outer surface around the opening of the outlet 11b is formed with a second assembly groove (not shown) so as to surround the outlet 11b. The second sealing member 30 is mounted in this second assembly groove. When the second sealing member 30 is mounted in the second assembly groove, the second sealing member 30 extends in an inclined flat manner to conform to the inclined flatness around the opening of the outlet 11b. In the present embodiment, the first sealing member 18 and the second sealing member 30 are provided by baking respectively to the first assembly groove and second assembly groove. In the present embodiment, the cross-sectional shape of each of the first sealing member 18 and the second sealing member 30 and the cross-sectional shape of each of the first assembly groove and the second assembly groove can be designed to be the same as those in each of the foregoing embodiments.

(Operations and Effects of EGR Valve Device)

The configuration of the EGR valve device 1 of the present embodiment described above can obtain the equivalent operations and effects to those in each of the foregoing embodiments.

The present disclosure is not limited to each of the foregoing embodiments, and may be embodied in other specific forms without departing from the essential characteristics thereof.

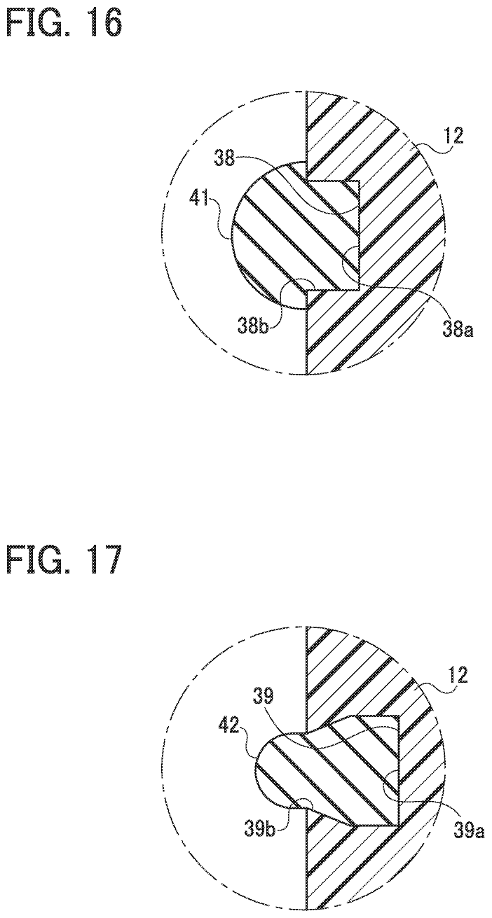

(1) In the third embodiment described above, the opening 36b of the second assembly groove 36 is formed with the width narrower than the width of the bottom surface 36a. As an alternative, as shown in FIG. 16, an assembly groove 38 may be formed with an opening 38b having the same width as that of a bottom surface 38a. In this case, as shown in FIG. 16, a sealing member 41 can be formed such that a portion corresponding to the assembly groove 38 has an outer shape matching the assembly groove 38 and a portion adjacent to the opening 38b is in contact with the outer surface of the housing 12. FIG. 16 is an enlarged cross-sectional view of the the assembly groove 38 and the sealing member 41, corresponding to FIG. 4.

(2) In the third embodiment described above, the opening 36b of the second assembly groove 36 is formed with the width narrower than that of the bottom surface 36a and a part of the second sealing member 27 is also in contact with the outer surface of the housing 12 adjacent to the opening 36b. As an alternative, as shown in FIG. 17, an assembly groove 39 may be formed with an opening 39b having a width narrower than that of a bottom surface 39a and a part of a sealing member 42 is not in contact with the outer surface of the housing 12 adjacent to the opening 39b. FIG. 17 is an enlarged cross-sectional view of the assembly groove 39 and the sealing member 42, corresponding to FIG. 4.

(3) In each of the foregoing embodiments, the shapes of portions of the sealing members 18, 19, 25, 27, and 29, corresponding to the assembly grooves 31, 32, 34, and 36, are designed with the same outer shapes as the shapes of the corresponding assembly grooves 31, 32, 34, and 36, and the sealing members 18, 19, 25, 27, and 29 are provided by baking to the corresponding assembly grooves 31, 32, 34, and 36. As an alternative, a portion of each sealing member corresponding to an assembly groove may be designed with a shape formed by addition of a tightening margin to the same outer shape as the shape of the assembly groove, and each sealing member may be provided by fitting into the assembly groove.

(4) In each of the foregoing embodiments, the housing 12 is made of a resin material and the outer housing 3 is made of a metal material. As an alternative, both of the housing and the outer housing may be made of either a metal material or a resin material.

(5) In each of the foregoing embodiments, the valve assembly 2 is configured to be assembled in the outer housing 3 which is a mating member. As an alternative, the mating member is not limited to the outer housing 3 and may include an EGR passage, an EGR cooler, an EGR gas distributor, and others.

### INDUSTRIAL APPLICABILITY

The present disclosure is applicable to for example an EGR device for regulating a flow rate of EGR gas in an engine system.

### REFERENCE SIGNS LIST

1 EGR valve device
3 Outer housing (Mating member)
11 Flow passage
11a Inlet
11b Outlet
12 Housing
14 Valve element
15 Valve shaft
18 First sealing member
19 Second sealing member
21 Mounting hole
22 Inlet flow passage (Another flow passage)
23 Outlet flow passage (Another flow passage)
25 Second sealing member
27 Second sealing member
29 Second sealing member
31 First assembly groove
32 Second assembly groove
32a Bottom surface
32b Opening
34 Second assembly groove
34a Bottom surface
34b Opening
36 Second assembly groove
36a Bottom surface
36b Opening
38 Assembly groove
38a Bottom surface
38b Opening
39 Assembly groove
39a Bottom surface
39b Opening
41 Sealing member
42 Sealing member

1. An EGR valve device comprising:
a housing including a flow passage for EGR gas, the flow passage including an inlet and an outlet provided in the housing;
a valve element to open and close the flow passage;
a valve shaft on which the valve element is provided;
a mating member in which the housing is assembled, the mating member including: an assembly hole for the housing; and another flow passage,
wherein when the housing is assembled in the assembly hole of the mating member, the inlet and the outlet of the flow passage communicate with the other flow passage, and a sealing member is provided between the housing and the mating member and located near the inlet and near the outlet, and
wherein the housing has an outer surface formed with an assembly groove in which the sealing member is assembled, the assembly groove including a bottom surface and an opening, and
the sealing member includes a portion corresponding to the assembly groove and having a shape that is either an outer shape matching the assembly groove or a shape formed by addition of a tightening margin to the outer shape.

2. The EGR valve device according to claim 1, wherein the bottom surface of the assembly groove is curved.

3. The EGR valve device according to claim 1, wherein the opening of the assembly groove has a width smaller than a width of the bottom surface.

4. The EGR valve device according to claim 1, wherein a part of the sealing member is in contact with an outer surface of the housing adjacent to the opening of the assembly groove.

5. The EGR valve device according to claim 1, wherein the sealing member is made of a rubber material filled in the assembly groove of the housing.

6. The EGR valve device according to claim 2, wherein the opening of the assembly groove has a width smaller than a width of the bottom surface.

7. The EGR valve device according to claim 2, wherein a part of the sealing member is in contact with an outer surface of the housing adjacent to the opening of the assembly groove.

8. The EGR valve device according to claim 3, wherein a part of the sealing member is in contact with an outer surface of the housing adjacent to the opening of the assembly groove.

9. The EGR valve device according to claim 6, wherein a part of the sealing member is in contact with an outer surface of the housing adjacent to the opening of the assembly groove.

10. The EGR valve device according to claim 2, wherein the sealing member is made of a rubber material filled in the assembly groove of the housing.

11. The EGR valve device according to claim 3, wherein the sealing member is made of a rubber material filled in the assembly groove of the housing.

12. The EGR valve device according to claim 4, wherein the sealing member is made of a rubber material filled in the assembly groove of the housing.

13. The EGR valve device according to claim 6, wherein the sealing member is made of a rubber material filled in the assembly groove of the housing.

14. The EGR valve device according to claim 7, wherein the sealing member is made of a rubber material filled in the assembly groove of the housing.

15. The EGR valve device according to claim 8, wherein the sealing member is made of a rubber material filled in the assembly groove of the housing.

16. The EGR valve device according to claim 9, wherein the sealing member is made of a rubber material filled in the assembly groove of the housing.
